(19) United States
(12) Patent Application Publication
(10) Pub. No.: US 2009/0144912 A1
(43) Pub. Date: Jun. 11, 2009

(54) TREATMENT OF PROTEINACEOUS, FIBROUS ENTITIES WITH BETA-KETOCARBONYL-FUNCTIONAL SILOXANE POLYMERS

(75) Inventors: Christian Herzig, Waging (DE); Eva-Maria Bienert, Altoetting (DE); Thomas Lehotkay, Muehldorf (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/304,406

(22) PCT Filed: May 23, 2007
(86) PCT No.: PCT/EP07/54981

§ 371 Date: Dec. 11, 2008

(30) Foreign Application Priority Data
Jun. 13, 2006 (DE) 10 2006 027 400.8

(51) Int. Cl. C14C 9/02

(52) U.S. Cl. 8/94.1 R

(57) ABSTRACT

Leather substrates are rendered water repellant by treatment with β-ketocarbonyl-functional siloxane polymers containing at least one radical of the formula

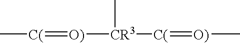

wherein R³ is hydrogen or a hydrocarbon radical.

The invention relates to a process for the treatment of protein-containing, fibrous substances, in particular leather or wool or wool articles, with β-ketocarbonyl-functional siloxane polymers.

It is known that leather left in the natural state is susceptible to environmental influences, such as dirt and moisture, owing to its chemical structure and its fibrous composition. In order to increase the serviceability of leather articles, a water-repellent property is desirable. Classical water repellents consist of high molecular weight, generally water-insoluble substances, such as waxes, paraffins and fatty acid condensates, which are advantageously made capable of being applied in the aqueous state with emulsifiers. The products give the leather a pleasant hand but often water repellency which is insufficient and is reproducible to a limited extent.

The systems were optimized by synthetic compositions, and here in particular the polysiloxanes and derivatives thereof. In addition to the strongly water-repellent property of the polysiloxanes, the hand properties, abrasion resistance and suppleness are simultaneously positively influenced and the permanence of the effects is increased.

In EP-0 213 480, simple nonfunctional silicone oils are brought into aqueous form by suitable emulsifiers and leather is rendered water repellent therewith.

Owing to the lack of functional groups on the siloxane molecule, however, the emulsifiability is greatly limited. The emulsions of different stability often give unreproducible results in the testing of the performance characteristics. Furthermore, the typical “silicone hand” which is often referred to as greasy and is caused by “bleeding” is undesired and adversely affects subsequent treatment processes, such as dyeing and finishability.

EP-A 0 324 345 describes a process for rendering leather and furs water repellent with self-emulsifiable or dispersible carboxy-functional polysiloxanes in aqueous emulsion. Here, the functions are attached both as side functions and as terminal functions to the polysiloxane skeleton and show good Bally penetrometer resistances when used with classical water repellents based on paraffin or wax emulsions.

However, the water repellent effect is still in need of improvement with regard to the water-repellent properties, permanence, flexibility and abrasion resistance in highly flexible apparel and shoes under extreme stress.

The modification of carbinol- or aminopolysiloxanes with diketene and derivatives thereof is described in U.S. Pat. No. 6,121,404. The products are used in aqueous solution together with aminopolysiloxanes for the production of elastomer films.

It was the object to provide a composition for the treatment of protein-containing, fibrous substances, in particular of leather or wool or wool articles, which has a water repellent effect. Furthermore, it was the object to provide an additive for leather treatment compositions which is suitable for the retanning and fatliquoring of leather which also meets more demanding requirements in use.

The invention relates to a process for the treatment of protein-containing, fibrous substances with compositions containing β-ketocarbonyl-functional siloxane polymers which contain at least one trivalent radical B of the general formula

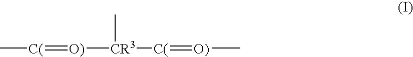

in which

R³ is a hydrogen atom or a monovalent hydrocarbon radical having 1 to 30 carbon atoms, preferably a hydrogen atom.

In the case of the radical B in formula (I), preferably not more than one of the three free valencies is bound to heteroatoms.

The siloxane polymers preferably contain at least 2 radicals B per average molecule, particularly preferably from 2 to 20 radicals B. The organic radicals B are bonded to the siloxane moiety of the siloxane polymers preferably via Si—C groups.

Where the trivalent radical B is not bonded by any of the free valencies to heteroatoms, the siloxane polymers according to the invention preferably contain at least one SiC-bonded radical B¹ selected from the group of the general formulae

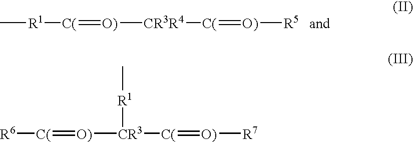

in which R³ has the meaning stated above therefor,
R¹ is a divalent organic radical, preferably a divalent organic radical having 1 to 20 carbon atoms, which, apart from in the terminal positions, may contain heteroatoms selected from the group consisting of oxygen, sulfur and nitrogen, preferably a hydrocarbon radical having 1 to 20 carbon atoms, particularly preferably a hydrocarbon radical having 1 to 4 carbon atoms,
R⁴ is a hydrogen atom or a hydrocarbon radical having 1 to 30 carbon atoms, preferably a hydrogen atom, and
R⁵, R⁶ and R⁷ are each a hydrocarbon radical having 1 to 30 carbon atoms.

The radicals B¹ of the formulae (II) and (III) have the structure of a substituted acetylacetone which is bonded via R¹ to a siloxane polymer.

Where the trivalent radical B is bonded by a free valency to heteroatoms, the siloxane polymers according to the invention preferably contain at least one SiC-bonded radical B² selected from the group of the general formulae

—R¹—Y—C(═O)—CHR³—C(═O)—CH₂R³ (IV) and

—R¹—Y—C(═O)—CR³═C(—OH)—CH₂R³ (V)

in which R¹ and R³ have the meanings stated above therefor,
Y is an oxygen atom or a radical of the formula —(NR⁸—R^{1′})_{z}—NR²—,
in which R^{1′} has the meaning of R¹,
R² is a hydrogen atom or a hydrocarbon radical having 1 to 18 carbon atoms, preferably a hydrogen atom,
R⁸ is R² or a radical of the formula —C(═O)—CHR³—C(═O)—CH₂R³ or —C(═O)—CR³═C(—OH)—CH₂R³,
z is 0 or an integer from 1 to 10, preferably 0, 1 or 2.

The radicals B² of the formulae (IV) and (V) are bonded via the radicals R¹ to the siloxane polymer.

The radicals B² of the formulae (IV) and (V) are tautomeric groups. Preferably, the siloxane polymers according to the invention contain at least 2 radicals B² from the group of the formulae (IV) and (V) per molecule, it being permitted for said siloxane polymers to contain only radicals of the formula (IV), only radicals of the formula (V) or both together. Since tautomeric groups can be converted into one another, their respective content can change depending on external conditions. Their quotient may therefore vary within wide ranges and quotients are from about 1000:1 to about 1:1000.

The enol content of the siloxane polymers according to the invention leads to a weakly acidic character of these substances, which depends to a decisive extent on the structural parameters and substituents of the group of the general formula (I). Preferably, this enolizable group has a pKa greater than 5.0, particularly preferably from 6.0 to 15.0, especially from 7.0 to 14.0.

The siloxane polymers according to the invention contain preferably from 5 to 5000 Si atoms, preferably from 50 to 1000 Si atoms, per molecule. They may be linear, branched, dendrimeric or cyclic. The range of the siloxane polymers according to the invention also includes network structures of any desired size, to which neither a specific nor an average number of Si atoms can be assigned if they contain at least 2 functional groups B of the formula (I).

The β-ketocarbonyl-functional siloxane polymers according to the invention are preferably organopolysiloxanes comprising units of the general formula

$${X}_{a} {{R}_{c} ( {OR}^{9} )}_{d} {SiO}_{\frac{4 - ( a + c + d )}{2}} , \qquad ( VI )$$

in which
X is an organic radical which contains the radical B, preferably an SiC-bonded radical B¹ or B², in which B, B¹ and B² have the meanings stated above therefor,
R is a monovalent, optionally substituted hydrocarbon radical having 1 to 18 carbon atoms per radical,
R⁹ is a hydrogen atom or an alkyl radical having 1 to 8 carbon atoms, preferably a hydrogen atom or a methyl or ethyl radical,
a is 0 or 1,
c is 0, 1, 2 or 3 and
d is 0 or 1,
   with the proviso that the sum a+c+d is ≦3 and on average at least one radical X is present per molecule.

Preferred examples of the β-ketocarbonyl-functional siloxane polymers according to the invention are organopolysiloxanes of the general formula

X_{g}R_{3-g}SiO(SiR₂O)ₗ(SiRXO)ₖSiR_{3-g}X_{g} (VIIa) and

(R⁹O)R₂SiO(SiR₂O)ₙ(SiRXO)ₘSiR₂(OR⁹) (VIIb)

in which A, R and R⁹ have the meanings stated above therefor,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical X is present per molecule.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl or tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl and methylcyclohexyl radicals; alkenyl radicals, such as the vinyl, 5-hexenyl, cyclohexenyl, 1-propenyl, allyl, 3-butenyl and 4-pentenyl radical; alkynyl radicals, such as the ethynyl, propargyl and 1-propynyl radical; aryl radicals, such as the phenyl, naphthyl, anthryl and phenanthryl radical; alkaryl radicals, such as o-, m- and p-tolyl radicals, xylyl radicals and ethylphenyl radicals; and aralkyl radicals, such as the benzyl radical and the α- and the β-phenylethyl radicals.

Examples of radicals R¹ are

—CH₂CH₂—, —CH(CH₃)—, —CH₂CH₂CH₂—, —CH₂C(CH₃)H—, —CH₂CH₂CH₂CH₂—, —CH₂CH₂CH(CH₃)— and —CH₂CH₂C(CH₃)₂CH₂—,
the —CH₂CH₂CH₂— radical being preferred.

Radical R^{1′} is a radical of the formula —CH₂CH₂— and —CH₂CH₂CH₂—.

Examples of radicals R³ are alkyl radicals, such as the methyl, ethyl, n-propyl, isopropyl, 1-n-butyl, 2-n-butyl, isobutyl, tert-butyl, n-pentyl, isopentyl, neopentyl or tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl and methylcyclohexyl radicals; aryl radicals, such as the phenyl, naphthyl, anthryl and phenanthryl radical; alkaryl radicals, such as o-, m- and p-tolyl radicals, xylyl radicals and ethylphenyl radicals; and aralkyl radicals, such as the benzyl radical and the α- and the β-phenylethyl radicals.

Examples of hydrocarbon radicals R³ also apply to hydrocarbon radicals R².

Examples of hydrocarbon radicals R³ also apply to hydrocarbon radicals R⁴, R⁵, R⁶ and R⁷.

Examples of hydrocarbon radicals R⁹ are alkyl radicals, such as the methyl, ethyl, n-propyl, isopropyl, 1-n-butyl, 2-n-butyl, isobutyl, tert-butyl, n-pentyl, isopentyl, neopentyl and tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical.

The radicals B¹ of the formulae (II) and (III) are β-diketone groups, which are either terminal, based on the diketone (formula (II)) or are bonded via R¹ to a siloxane polymer at the carbon atom between the two carbonyl groups (formula (III)).

Processes for the preparation of β-ketocarbonyl-functional siloxane polymers having radicals B¹ of the formula (II) are known from organic chemistry. They are preferably obtained via the acylation of acetoacetates with organosilicon compounds which contain Si-bonded acid chlorides. If, for example, siloxane polymers which contain Si-bonded undecanoyl chloride (R¹=—C₁₀H₂₀—) are reacted with ethyl acetoacetate (CH₃—C(═O)—CH₂—C(═O)—O—CH₂CH₃) (acylation) and CO₂ and ethanol are then eliminated thermally, siloxane polymers which contain radicals B¹ of the formula (II) with R¹=—C₁₀H₂₀—, R³=H, R⁴=H and R⁵=—CH₃ are obtained.

Processes for the preparation of β-ketocarbonyl-functional siloxane polymers which contain radicals B¹ of the formula (III) are described in DE 1193504 A and DE 1795563 A. The hydrosilylation of allylacetylacetone is preferred here, siloxane polymers which contain radicals B¹ of the formula (III) with R¹=—C₃H₆—, R³=H, R⁶=R⁷=—CH₃ forming. A preferred process is furthermore the alkylation of acetylacetone by siloxane polymers having Si-bonded halogen groups, such as —CH₂Cl, —CH₂Br, —C₃H₆Cl or —C₃H₆I.

Processes for the preparation of siloxane polymers which contain radicals B² of the formulae (IV) and (V) are described in U.S. Pat. No. 6,121,404 A.

They are preferably prepared by reacting diketenes (1) of the general formula

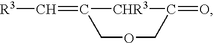

in which R³ has the meaning stated above therefor and is preferably a hydrogen atom,
with organosilicon compounds (2) which contain at least one Si-bonded radical A of the general formula

—R¹—(NR²—R^{1′})_{z}—NR²₂ (VIII)

per molecule, R¹, R^{1′}, R² and z having the meanings stated above therefor,
with the proviso that the radical A of the formula (VIII) has at least one primary and optionally at least one secondary amino group, preferably at least one primary amino group.

The reaction is preferably effected in the presence of organic compounds (3) which retard or prevent the reaction of primary or secondary amino groups with β-ketocarbonyl compounds.

Preferably used organic compounds (3) are those which give more or less strong adducts with amines. Examples of compounds (3) are aldehydes and ketones. Preferred examples are acetone, butanone, methyl isobutyl ketone and cyclohexanone.

In a preferred preparation process, organosilicon compounds (2) are reacted with organic compounds (3) in a 1st stage, the compounds (3) forming protective groups on the amino groups in the radical A of the formula (VIII), and the organosilicon compounds (2) obtained in the 1st stage and having the protected amino groups (reaction products of (2) and (3)) are then reacted with diketenes (1) in a 2nd stage. In the reaction with diketene, the protective group is eliminated again from the amino group in the radical A of the formula (VIII).

The radical A of the formula (VIII) may also be an α-amino radical of the formula —CH₂—NR²—H. In this case, the concomitant use of organic compounds (3) is not preferred in the preparation.

Examples of radicals A are

CH₂—NH₂

—CH(CH₃)—NH₂

—C(CH₃)₂—NH₂

—CH₂CH₂—NH₂

—CH₂CH₂CH₂—NH₂

—CH₂CH₂CH₂CH₂—NH₂

—CH₂CH₂CH(CH₃)—NH₂

—CH₂CH₂CH₂—NH—CH₂CH₂—NH₂

—CH₂CH₂CH₂—N(CH₃)—CH₂CH₂—NH₂

—CH₂CH₂CH₂[—NH—CH₂CH₂]₂—NH₂

—CH₂CH₂C(CH₃)₂CH₂—NH₂,

—CH₂CH₂CH₂—NH₂ and —CH₂CH₂CH₂—NH—CH₂CH₂—NH₂ being preferred.

Preferred examples of radicals B are therefore

—CH₂CH₂CH₂—NH(-Z) and

—CH₂CH₂CH₂—NH₁₋ₓ(-Z)ₓ-CH₂CH₂—NH(-Z),

Z being radicals of the formulae

—C(═O)—CHR³—C(═O)—CH₂R³ or

—C(═O)—CR³═C(—OH)—CH₂R³,

R³ has the meaning stated above therefor and is preferably a hydrogen atom and
x is 0 or 1.

Examples of protein-containing, fibrous substances which are treated by the process according to the invention are leather, wool and wool articles, leather being preferred.

The treatment can be effected during or after the retanning of leather.

The β-ketocarbonyl-functional siloxane polymers according to the invention are preferably used as solutions in organic solvents.

Compositions containing β-ketocarbonyl-functional siloxane polymers according to the invention and organic solvents are therefore preferably used.

Examples of organic solvents are isopropanol, toluene, tetrahydrofuran, mineral spirit and benzine fractions.

The β-ketocarbonyl-functional siloxane polymers according to the invention are present in the solutions in amounts of, preferably, from 5 to 50% by weight, preferably from 10 to 30% by weight.

Furthermore, the β-ketocarbonyl-functional siloxane polymers according to the invention are preferably used in the form of aqueous emulsions or dispersions in the process according to the invention for the treatment of protein-containing, fibrous substances.

Compositions containing

β-ketocarbonyl-functional siloxane polymers,
emulsifiers and
water
are therefore preferably used.

The β-ketocarbonyl-functional siloxane polymers according to the invention are present in the aqueous emulsions in amounts of, preferably, from 5 to 60% by weight, preferably from 10 to 50% by weight.

Suitable emulsifiers or dispersants are in principle all surface-active substances, in particular of the nonionic and anionic type, which can stabilize the β-ketocarbonyl-functional polysiloxanes according to the invention in water. Anionic emulsifiers, such as ethoxylated oleyl- or tallow fat-based phosphoric acid esters, N-oleylsarcoside, N-stearylsarcoside or N-laurylsarcoside, and suitable sulfosuccinate derivatives are particularly preferred.

The emulsifiers are present in the aqueous emulsions in amounts of, preferably, from 2 to 20% by weight, preferably from 4 to 10% by weight.

The treatment of the protein-containing, fibrous substances, in particular leather, with the compositions according to the invention, preferably in the form of solutions or aqueous emulsions, is preferably effected at a pH of from 4 to 7, preferably from 5 to 7.

The pH is preferably adjusted with the aid of sodium hydroxide solution.

The compositions according to the invention, preferably in the form of solutions or aqueous emulsions, are allowed to act on the protein-containing, fibrous substances, in particular leather, preferably at a temperature of from 10 to 70° C., preferably from 20 to 50° C.

The action time is preferably from 20 to 150 minutes, preferably from 20 to 90 minutes.

The process according to the invention is preferably carried out at the pressure of the ambient atmosphere, i.e. at about 1020 hPa. However, it can also be carried out at higher or lower pressures.

The process according to the invention has the advantage that the treatment composition both acts on the surface of the leather as a thin film and is capable of penetrating into the leather and coating the “leather fibers”, the breathable properties being retained.

For the use of the β-ketocarbonyl-functional polysiloxanes according to the invention, an outstanding, permanent water repellent effect in combination with improvement of the hand quality is achieved.

This is permitted by the particular chemical structure of the polysiloxane. The hydrophobic and hand-imparting properties are brought about by the uninterrupted polysiloxane skeleton. The organic units influence the emulsifying and dissolution properties for the aqueous and solvent-containing formulation positively.

The terminal carbonyl groups are capable of chelating the metal ions present in the leather and forming stabilizing hydrogen bridge bonds. The fixing increased thereby permits greater permanence of the polysiloxane on the leather skeleton.

Here, the water repellent is as a rule applied in the drum by the exhaustion method and must therefore be converted into an aqueous form for this purpose. Emulsifiers and/or dispersants which stabilize the emulsion/dispersion and additionally enhance the deep effect of the water repellency are used for this purpose.

The compositions used in the process according to the invention may additionally contain waxes of natural or synthetic origin, solubilizers based on glycols and glycol ethers and further additives, such as retanning agents of natural or synthetic origin.

In order to optimize in particular the water repellent effect of leather, the subsequent treatment of the leather with polyvalent metal salts of valencies two to four, in particular chromium, aluminum or zirconium sulfate, can be effected.

### Preparation of the β-Ketocarbonyl-Functional Siloxane Polymers:

### EXAMPLE 1

136.5 g of a commercially available aminosiloxane comprising 3-(aminoethylamino)propylmethylsilyloxy and dimethylsilyloxy units and terminal methoxy groups and having an amine content of 0.293 meq/g at a viscosity of 980 mm²/s are stirred with 4.7 g of acetone for 4 hours at 25° C. This is followed by the addition of 3.7 g of diketene, whereupon a slight temperature increase begins. After a further 2 hours, the acetone is removed at 70° C. in vacuo. A clear, yellowish oil having a viscosity of 4900 mm²/s (25° C.) is obtained. The ¹H-NMR spectrum indicates complete amine conversion. The β-ketoamidosiloxane has a keto/enol ratio of 3.0. The primary as well as the secondary amino groups were acetoacetylated.

### EXAMPLE 2

136.5 g of a commercially available aminosiloxane comprising 3-(aminoethylamino)propylmethylsilyloxy and dimethylsilyloxy units and terminal methoxy groups and having an amine content of 0.293 meq/g at a viscosity of 980 mm²/s are stirred with 3.6 g of acetone for 4 hours at 25° C. This is followed by the addition of 3.7 g of diketene, whereupon a slight temperature increase begins. After a further 2 hours, the acetone is removed at 70° C. in vacuo. A clear, yellowish oil having a viscosity of 13 000 mm²/s (25° C.) is obtained. The 1H-NMR spectrum indicates complete amine conversion. The β-ketoamidosiloxane has a keto/enol ratio of 3.0. The primary as well as the secondary amino groups were acetoacetylated.

### EXAMPLE 3

1350 g of an α,ω-dihydroxypolydimethylsiloxane having a viscosity of 67 mm²/s (25° C.) are mixed with 74 g of cyclohexylaminomethyl-methyldiethoxysilane. The mixture is heated to 80° C. and, after 2 hours and application of a vacuum, stirred until a constant viscosity is reached. The ethanol eliminated is removed continuously, whereupon an aminopolysiloxane with 2940 mm²/s (25° C.) is obtained. The colorless, clear oil has an amine number of 0.204 meq/g and thus contains on average one secondary amino group per 4902 g of polymer. The aminopolysiloxane is mixed at 26° C. with 25 g of diketene. With stirring, the internal temperature increases by 12° C. in the course of 15 minutes. The reaction is allowed to continue for a further 2 hours without external heating, and a virtually colorless silicone polymer having a viscosity of 3220 mm²/s (25° C.) is obtained in virtually quantitative yield.

### EXAMPLE 4

At 22° C., 1605 g of a dimethylpolysiloxane having terminal aminopropyl groups and an amine content of 0.78 meq/g are mixed with 24.4 g of acetone. After about 4 hours, a total of 17.7 g of diketene are metered in uniformly and with thorough stirring in about 1 minute. During a slightly exothermic reaction, the viscosity of the amine oil increases substantially. Without external heating, the reaction is allowed to continue for a further 2 hours and the added acetone is removed in vacuo at 70° C. A clear, yellowish oil having a viscosity of 1080 mm²/s (25° C.) is obtained. The 1H-NMR spectrum indicates a keto/enol ratio of the resulting β-ketoamidosiloxane of 5.0; the amine conversion is complete (>99%).

### Imparting Water Repellency to Leather:

### EXAMPLE 5 AND COMPARATIVE EXPERIMENT

The determination of the water repellency effect was carried out by application to 5×5 cm leather pieces. For this purpose, by way of example, chrome-tanned leather pieces are immersed in a 5% strength solution of the β-ketocarbonyl-functional siloxane polymers according to the invention in isopropanol and mineral spirit at room temperature for about 2 hours.

In each case a 5% strength solution of a dimethylpolysiloxane (nonfunctional siloxane) having a viscosity of 350 mPa·s at 25° C. in isopropanol and mineral spirit is used as a comparison.

The sample is then dried at 50° C. and weighed (=weight W1) and subjected to repetitive compressions in the presence of the external action of water in a Bally penetrometer. In this procedure, leather immersed with the grain side in water is flexed over a predetermined distance (=compression) and stretched again, as in the case of upper leather when the shoe is worn. The passage of water is determined conductometrically. The time when the water penetrates through the leather is measured. The sample is finally weighed (=weight W2) and the water absorption is determined from the weight difference.

$$water absorption \frac{W 1 - W 2}{W 1} \times 100 \%$$

The longer the time in the case of the Bally water passage and the lower the water absorption, the better the water repellency effect. The siloxane polymers according to the invention show a substantially better water repellency effect than the comparison with a customary nonfunctional dimethylpolysiloxane.

The results are listed in the following table:

TABLE

| Sample | | Water | Bally water |
|---|---|---|---|
| designation | Solvent | absorption [%] | passage [min] |
| Example 1 | mineral spirit | 22 | 317 |
| Comparison | mineral spirit | 46 | 14 |
| Example 1 | isopropanol | 27 | 320 |
| Example 2 | isopropanol | 21 | 403 |
| Example 3 | isopropanol | 33 | 62 |
| Example 4 | isopropanol | 20 | 393 |
| Comparison | isopropanol | 33 | 15 |

1-11. (canceled)

12. A process for the treatment of leather and leather fiber substrates, comprising treating the substrate with a composition comprising β-ketocarbonyl-functional siloxane polymers which contain at least one trivalent radical B of the formula 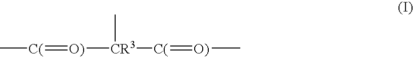
in which
R³ each individually is a hydrogen atom or a monovalent hydrocarbon radical having 1 to 30 carbon atoms.

13. The process of claim 12, wherein at least one radical B is an SiC-bonded radical B¹ of the formulae 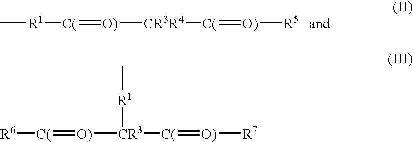
in which
R¹ is a divalent organic radical,
R⁴ is a hydrogen atom or a hydrocarbon radical having 1 to 30 carbon atoms, and
R⁵, R⁶ and R⁷ are each a hydrocarbon radical having 1 to 30 carbon atoms.

14. The process of claim 12, wherein at least one radical B is an SiC-bonded radical B² of the formulae
—R¹—Y—C(═O)—CHR³—C(═O)—CH₂R³ (IV) and
—R¹—Y—C(═O)—CR³═C(—OH)—CH₂R³ (V)
in which R¹ is a divalent organic radical,
Y is an oxygen atom or a radical of the formula —(NR⁸—R^{1′})_{z}—NR²—,
in which R^{1′} has the meaning of R¹,
R² is a hydrogen atom or a hydrocarbon radical having 1 to 18 carbon atoms,
R⁸ is R² or a radical of the formula —C(═O)—CHR³—C(═O)—CH₂R³ or —C(═O)—CR³═C(—OH)—CH₂R³, and
z is 0 or an integer from 1 to 10.

15. The process of claim 14, wherein z is 0, 1, or 2.

16. The process of claim 14, wherein at least one radical B² is an Si—C bonded radical of the formulae
—CH₂CH₂CH₂—NH(-Z) and/or
—CH₂CH₂CH₂—NH₁₋ₓ(-Z)ₓ-CH₂CH₂—NH(-Z),
Z being radicals of the formulae
—C(═O)—CHR³—C(═O)—CH₂R³ or
—C(═O)—CR³═C(—OH)—CH₂R³, and
x is 0 or 1.

17. The process of claim 12, wherein organopolysiloxanes comprising units of the formula
$${X}_{a} {{R}_{c} ( {OR}^{9} )}_{d} {SiO}_{\frac{4 - ( a + c + d )}{2}} , \qquad ( VI )$$
are employed as siloxane polymers,
in which
X is an organic radical which contains the radical B,
R is a monovalent, optionally substituted hydrocarbon radical having 1 to 18 carbon atoms per radical,
R⁹ is a hydrogen atom or an alkyl radical having 1 to 8 carbon atoms,
a is 0 or 1,
c is 0, 1, 2 or 3 and
d is 0 or 1,
with the proviso that the sum a+c+d is ≦3 and on average at least one radical X is present.

18. The process of claim 12, wherein at least one siloxane polymer is an organopolysiloxane of the formulae
X_{g}R_{3-g}SiO(SiR₂O)ₗ(SiRXO)ₖSiR_{3-g}X_{g} (VIIa) and/or
(R⁹O)R₂SiO(SiR₂O)ₙ(SiRXO)ₘSiR₂(OR⁹) (VIIb)
in which
X is an organic radical which contains the radical B,
R is a monovalent, optionally substituted hydrocarbon radical having 1 to 18 carbon atoms per radical,
R⁹ is a hydrogen atom or an alkyl radical having 1 to 8 carbon atoms,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical X is present.

19. The process of claim 17, wherein the radicals X are SiC-bonded radicals B¹ or SiC-bonded radicals B², wherein radicals B¹ are of the formula 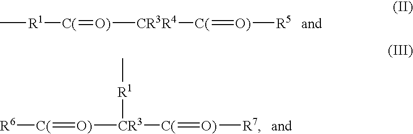
wherein radicals B² are of the formula
—R¹—Y—C(═O)—CHR³—C(═O)—CH₂R³ (IV) and
—R¹—Y—C(═O)—CR³═C(—OH)—CH₂R³ (V)
in which R¹ is a divalent organic radical,
Y is an oxygen atom or a radical of the formula —(NR⁸—R^{1′})—NR²—,
in which R^{1′} has the meaning of R¹,
R² is a hydrogen atom or a hydrocarbon radical having 1 to 18 carbon atoms,
R⁸ is R² or a radical of the formula —C(═O)—CHR³—C(═O)—CH₂R³ or —C(═O)—CR³═C(—OH)—CH₂R³, and
z is 0 or an integer from 1 to 10.

20. The process of claim 17, wherein the radicals X are SiC-bonded radicals B¹ or SiC-bonded radicals B², wherein radicals B¹ are of the formula 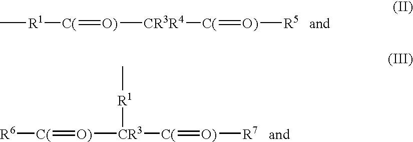
wherein radicals B² are of the formula
—CH₂CH₂CH₂—NH(-Z) and/or
—CH₂CH₂CH₂—NH₁₋ₓ(-Z)ₓ-CH₂CH₂—NH(-Z),
Z being radicals of the formulae
—C(═O)—CHR³—C(═O)—CH₂R³ or
—C(═O)—CR³═C(═OH)—CH₂R³, and
x is 0 or 1.
